(19) United States
(12) Patent Application Publication
(10) Pub. No.: US 2020/0077605 A1
(43) Pub. Date: Mar. 12, 2020

(54) Automated Data-Based Irrigation System and Method

(71) Applicant: Darren Raj, Tallahassee, FL (US)

(72) Inventor: Darren Raj, Tallahassee, FL (US)

(21) Appl. No.: 16/683,523

(22) Filed: Nov. 14, 2019

Related U.S. Application Data
(63) Continuation of application No. 15/422,551, filed on Feb. 2, 2017, now abandoned.
(60) Provisional application No. 62/360,753, filed on Jul. 11, 2016.

(51) Int. Cl. A01G 25/16; G05D 1/00; B64C 39/02

(52) U.S. Cl. CPC A01G 25/165; A01G 25/167; G05D 1/0094; B64C 2201/027; B64C 2201/123; B64C 2201/127; B64C 39/024

(57) ABSTRACT

A system and method for obtaining real-time data regarding the condition of a crop and planning and executing an irrigation cycle in response to the data. The invention uses an unmanned aerial vehicle to survey the conditions within an irrigated area. The irrigation system includes components to vary the amount of water dispensed within particular areas. The data obtained is used to create an irrigation schedule that the irrigation system then carries out. For example, surveyed areas that contain more moisture may be given relatively less water during the next irrigation cycle. The data obtained may also be used to alter a scheduled delivery of fertilizer, pesticide, or some other substance.

### CROSS-REFERENCES TO RELATED APPLICATIONS

This non-provisional patent application is a continuation of U.S. patent application Ser. No. 15/422,551. The parent application lists the same inventor and contains the same disclosure as the present application.

### STATEMENT REGARDING FEDERALLY SPONSORED RESEARCH OR DEVELOPMENT

Not applicable

### MICROFICHE APPENDIX

Not applicable

### BACKGROUND OF THE INVENTION

### 1. Field of the Invention

This invention relates to the field of agriculture. More specifically, the invention comprises a system and method for obtaining real-time data regarding the condition of a crop and planning and executing an irrigation cycle in response to the data.

### 2. Description of the Related Art

The present invention is applicable to a wide variety of irrigation systems and should not be viewed as being limited to any one type. However, it is useful for the reader to have some background knowledge of a particular type of irrigation system so that the invention's application to that type can be explained in detail. “Center pivot” irrigation systems are now quite common throughout the world, and this type will be used in the examples provided.

FIGS. 1 through 3 illustrate the components of a typical center pivot system. FIG. 1 shows a perspective view. As the components are relatively large, the vantage point of FIG. 1 represents an “aerial” view from an altitude of about 100 feet. Central pivot structure 12 is located in the center of the circular area to be irrigated. A line of booms (commonly referred to as “spans”) is connected to the central pivot structure. Boom assembly 14 connects directly to the central pivot structure. Boom assembly 16 connects to boom assembly 14 at drive tower 20. Boom assembly 18 connects to boom assembly 16 at drive tower 22. Drive tower 24 is located on the outer end of boom assembly 18. End boom 26 (which typically mounts a sweeping nozzle) is also mounted to drive tower 24.

Water is pumped in through center pivot structure 12 and carried along the boom assemblies. Many spray nozzles are mounted along the boom assemblies. These nozzles distribute the water. The drive towers include geared drive motors (typically electric motors) that slowly move the booms around the irrigation circle. While a detailed discussion of the operation of center pivot systems is beyond the scope of this disclosure, the reader may wish to know a few basic facts about their operation. In many systems, the outermost drive tower is driven at a controlled rate. The inner drive towers are simply “keyed” off the motion of the outer drive tower. For instance, boom assembly 18 is joined to boom assembly 16 across a flexible joint near the top of drive tower 22. This flexible joint includes an angular sensor. The angular sensor “trips” when boom assembly 18 exceeds a small angle with respect to boom assembly 16 (the two booms become non-parallel). When this sensor trips the drive within drive tower 22 is activated and drive tower 22 drives in the same direction as drive tower 24. In this example all the drive towers operate at the same linear speed. However, since drive tower 22 is running along a smaller circle than drive tower 24, it will soon overtake the angular position of drive tower 24. This will be sensed by the fact that boom assembly 16 again becomes parallel with boom assembly 18 (or nearly so). Drive tower 22 will then be shut off until the angular sensor on the flexible joint on drive tower 22 again senses that the boom assemblies are non-parallel.

The same type of angular sensor is provided on the flexible joint at drive tower 20. In this operational scheme, drive tower 24 is activated for a fixed period and drives at a set rate. Drive towers 20 and 22 periodically activate to drive forward and keep the boom assemblies parallel. The result is that the three aligned booms pivot around central tower structure 12. They act as a single linear structure.

FIG. 2 shows center pivot structure 12 and boom assembly 14 in more detail. The vertical water feed pipe on the center pivot structure is connected to elbow 30 via collector ring 28. The collector ring allows the pressurized water to be transferred through a freely-rotating joint. The collector ring also often includes a rotating connection for electrical power (such as 440 VAC) and electrical control circuitry (110 VAC or sometimes low-voltage DC).

Pipe 34 is connected to elbow 30 via joint 32. The pipe may be arched as shown for greater structural strength. The pipe may be large (such as 10 inches or 25 cm in diameter). The overall length of the boom assembly may be 40 feet (2+meters). The weight of the water carried in the pipe is quite significant (about 1,400 pounds or 640 kg). The bending forces on so slender a structure are also significant. Thus, these systems typically include reinforcing structure. The pipe shown in FIG. 2 includes a series of truss assemblies 36. The outer portions of the truss assemblies are connected by guy wires 38. These guy wires are tensioned to add strength and rigidity to the overall structure.

The outer portion of pipe 34 is joined to the next pipe via flex joint 50 on top of drive tower 20. Drive tower 20 includes a pair of drive wheels 42 that are driven by an electric gear motor. The drive tower may also include a small sprinkler boom that is perpendicular to pipe 34. This small boom mounts one or more sprinkler heads that are used to irrigate areas within the arc of the drive tower's motion.

Most of the irrigation provided comes from pipe 34 itself. A series of U-couplings 44 come off the top of the pipe. Each of these couplings is connected to a pendant 46. Each pendant includes a liquid dispenser of some type (in this case sprinkler head 48 located near its lower end). Each pendant also typically includes a weight to hold the pendant steady. In operation, pressurized water leaves the pipe through the U-couplings, descends through the attached pendants, and sprays out through the sprinkler heads onto the crop.

FIG. 3 shows the same assembly in a plan view. Irrigation circle 52 is centered on center pivot structure 12. Boom assembly 14 covers inner boom area 60. Boom assembly 16 covers middle boom area 58. Boom assembly 18 covers outer boom area 56. End boom 26 covers end boom area 54. Those skilled in the art will know that most such systems have more than three boom assemblies. It is more common for such systems to have many more boom assemblies (such as ten boom assemblies). However, the principles of operation are the same for the larger versions.

Those skilled in the art will also know that such irrigation systems may be used to carry more than just water. Many other things may be dissolved in (or carried by) the water. These other things include fertilizers and pesticides.

FIG. 4 shows a prior art unmanned aerial vehicle 62 (“UAV” or “drone”). UAV's come in many different configurations and the invention is by no means limited to any particular configuration. The version shown includes four separate powered rotors 66. Frame 64 surrounds and guards the rotors. Landing gear 70 in this version comprise four spring steel legs—each of which includes a soft landing pad.

Sensor array 68 is mounted to the bottom of UAV 62 and is oriented in a downward direction. The sensor array may include a wide variety of passive and active sensors. As one example, a short wavelength infrared (“SWIR”) sensor has been found useful in determining the moisture content of crops being surveyed. The sensor array may contain one or more SWIR receptors.

The present invention uses the UAV to survey the soil and/or crop growing (and more specifically the crop canopy) within an irrigated area. The invention then uses the data obtained to tailor an irrigation cycle for the irrigated area.

### BRIEF SUMMARY OF THE INVENTION

The present invention comprises a system and method for obtaining real-time data regarding the condition of a crop and planning and executing an irrigation cycle in response to the data. The invention uses an unmanned aerial vehicle to survey the conditions within an irrigated area. The irrigation system includes components to vary the amount of water dispensed within particular areas known as “zones.” The data obtained is used to create an irrigation schedule that the irrigation system then carries out (often known as “zone management”). For example, surveyed areas that contain more moisture may be given relatively less water during the next irrigation cycle. The data obtained may also be used to alter a scheduled delivery of fertilizer, pesticide, or some other substance.

### BRIEF DESCRIPTION OF THE SEVERAL VIEWS OF THE DRAWINGS

FIG. 1 is a perspective view, showing a prior art center pivot irrigation system.

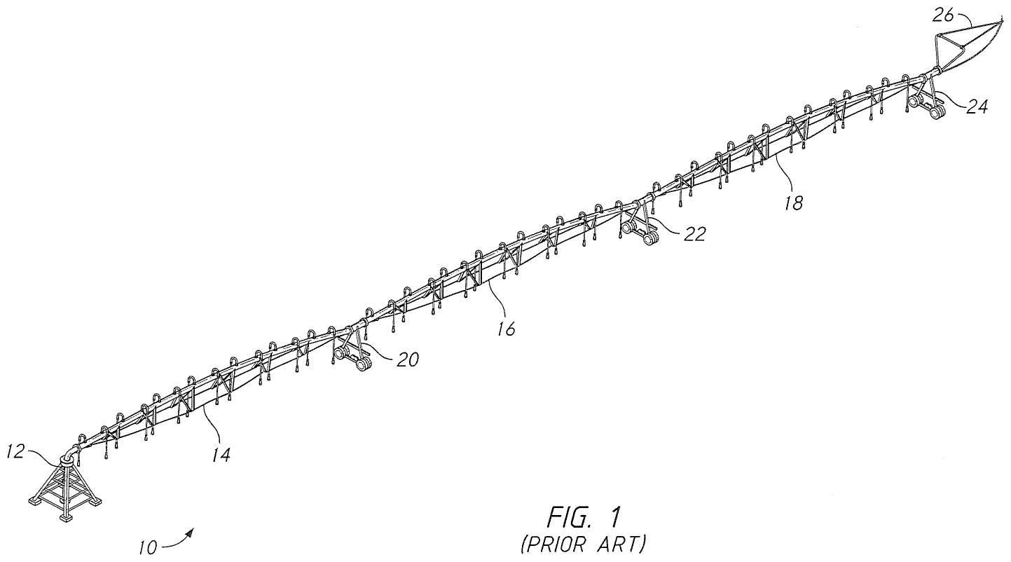

FIG. 2 is a detailed perspective view, showing the center pivot structure and the first boom assembly of the system from FIG. 1.

FIG. 3 is a plan view, showing the system from FIG. 1.

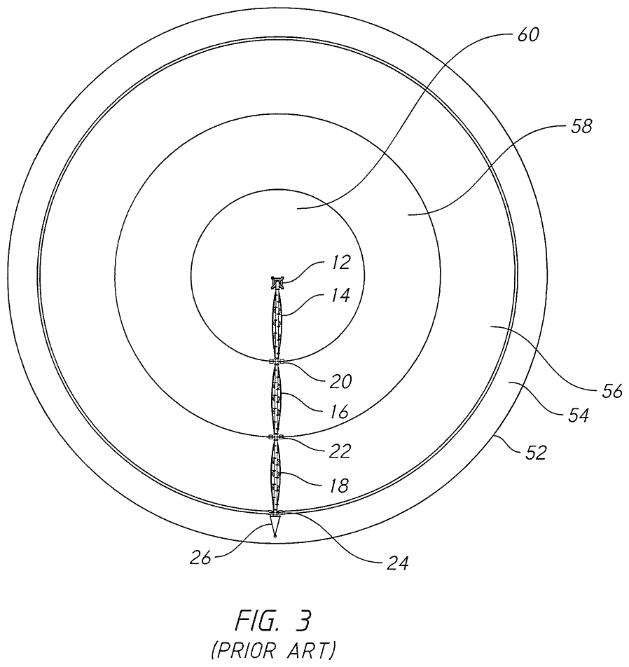

FIG. 4 is a perspective view, showing a prior art UAV.

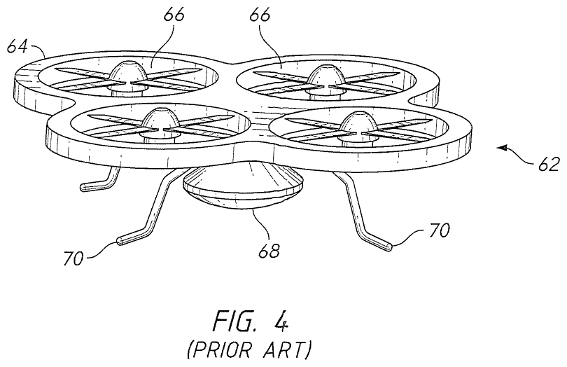

FIG. 5 is a detailed perspective view, showing a UAV base station as used in some embodiments of the present invention.

FIG. 6 is a plan view, showing some exemplary survey data.

FIG. 7 is a plan view, showing an exemplary survey pattern.

FIG. 8 is a plan view, showing an exemplary irrigation schedule (“zone map”)

FIG. 9 is a pan view, showing another exemplary survey pattern.

### REFERENCE NUMERALS IN THE DRAWINGS

10 center pivot irrigation system
12 central pivot structure
14 boom assembly
16 boom assembly
18 boom assembly
20 drive tower
22 drive tower
24 drive tower
26 end boom
28 collector ring
30 elbow
32 joint
34 pipe
36 truss assembly
38 guy wire
42 drive wheel
44 U-coupling
46 pendant
48 sprinkler head
50 flex joint
52 irrigation circle
54 end boom area
56 outer boom area
58 middle boom area
60 inner boom area
62 unmanned aerial vehicle
64 frame
66 rotor
68 sensor array
70 landing gear
72 UAV landing pad
74 mounting chassis
76 cover
78 hinge
80 actuator
82 target
84 control cable
86 outlet
88 valve
90 connector
92 mildly dry region
94 moderately dry region
96 oversaturated region
98 UAV base station
100 flight path
102 transceiver
104 CPU/memory
106 sprinkler coverage arc
108 wheel tracks

### DETAILED DESCRIPTION OF THE INVENTION

The present invention seeks to use real-time or near-real-time data collected by an unmanned aerial vehicle (“UAV”) to modify the application of water and waterborne substances through an irrigation system. The invention can be used with any desired type of irrigation system. However, since a center pivot system was used for the description of the prior art, the embodiments disclosed hereafter pertain to a center pivot system.

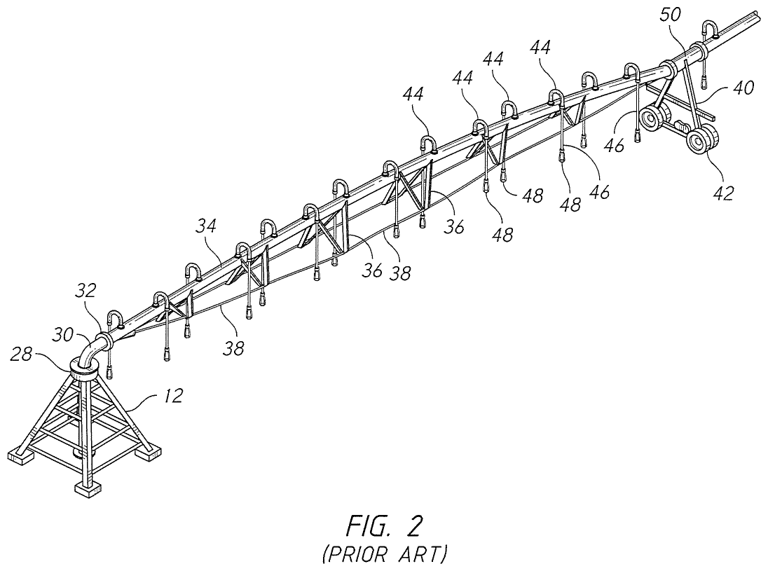

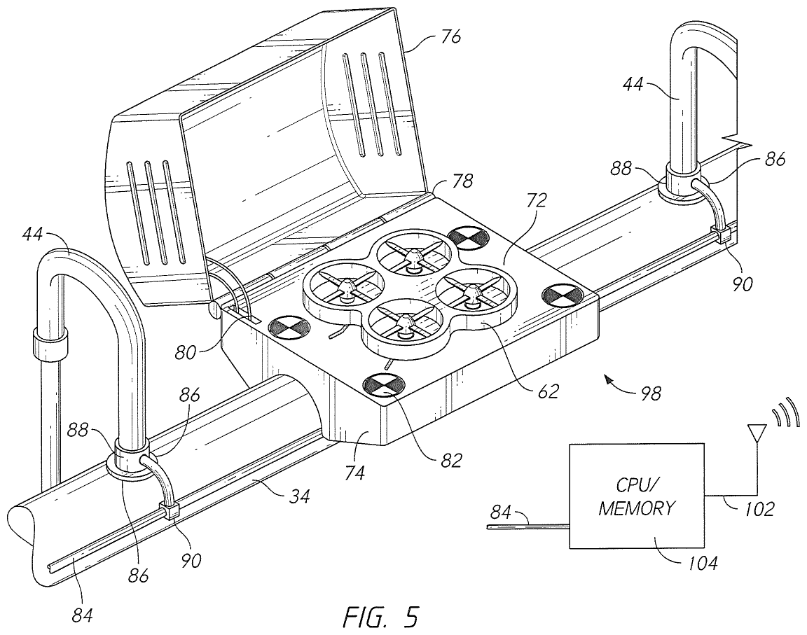

The UAV is preferably stored on or near the irrigation area to be surveyed so that it does not waste time in transit. A landing pad and housing could be provided on a pole near the field. However, since the irrigation system already provides a substantial structure, it is preferable to use this structure to house the UAV. Returning briefly to FIG. 2, the reader will recall that a boom assembly of a center pivot system includes a large pipe 34. FIG. 5 shows an enlarged view of UAV base station 98 mounted on pipe 34.

The UAV base station includes a flat UAV landing pad 72 atop a mounting chassis 74. The mounting chassis in this version is attached to pipe 74 using two metal straps. Cover 76 pivots down over UAV landing pad 72 (via hinge 78). Actuator 80 moves the cover between the open position (shown) and a closed position where it completely covers the UAV landing pad.

Targets 82 are provided to guide the UAV onto the pad. There are many known UAV guidance systems and the invention is not limited to any particular one. However, in this version, a GPS receiver on board the UAV is used to guide it to a position just over the landing pad. A digital vision system in the UAV's sensor array then looks for the targets 82 and uses these to guide the UAV to a landing in the center of the pad. Once the UAV has landed, actuator 80 closes cover 76 over the UAV in order to protect it. The UAV remains under the cover when not in use and is thereby protected from sun, wind, and rain.

The UAV landing pad includes an inductive charging system that recharges the UAV's internal batteries as the UAV sits on the pad. Energy may be provided from a solar panel or panels on top of cover 76. However, as power is typically provided along the boom assembly, this power may be tapped to recharge the UAV batteries. For example, control cable 84 typically carries a low-power DC signal with sufficient capacity to recharge the UAV batteries.

FIG. 5 shows additional details of an irrigation system modified according to the present invention. In the prior art, each U-coupling 44 is connected to an outlet 86 along the top of pipe 34. In the inventive embodiment shown, a valve 88 controls the flow of liquid from outlet 86 into U-coupling 44 (and from thence to the attached sprinkler head or heads). Each valve 88 is in turn connected by a connector 90 to control cable 84. Control cable 84 contains multiple conductors.

Control cable 84 is connected to CPU/memory 104. The CPU (central processing unit)/memory may be remotely located or may be part of a control box assembly mounted on center pivot structure 12. It is attached to a transceiver 102 configured to communicate with the UAV.

In operation, the UAV flies a pattern to collect data in the irrigation area. The UAV or its associated landing station then transfers the data collected to CPU/memory 104 via transceiver 102. The CPU/memory then uses the data to create a desired operating scheme for the irrigation system as a whole and valves 88 in particular. Some exemplary operating schemes will now be described in more detail.

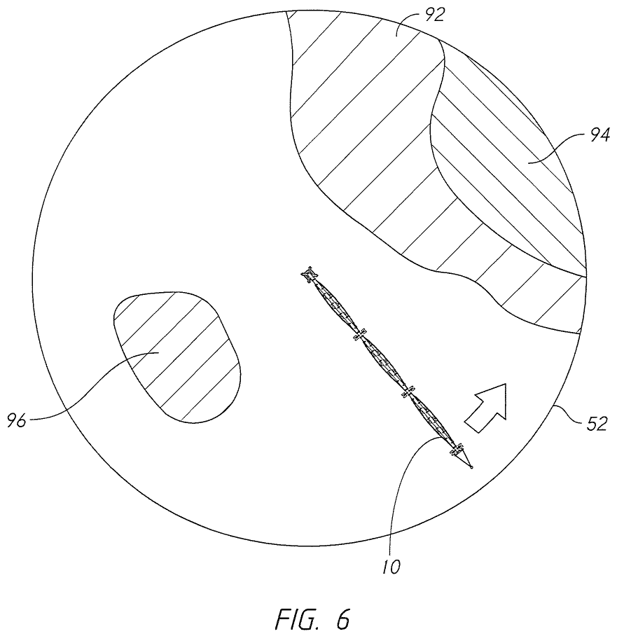

FIG. 6 shows a possible state for irrigation circle 52. The moisture content of the soil and/or crop within the circle is not evenly distributed. Oversaturated region 96 exists, as do mildly dry region 92 and moderately dry region 94. Prior art irrigation systems are typically designed to provide a uniform distribution of water. If this is done in the field shown in FIG. 6, some regions will be overwatered and others will be underwatered.

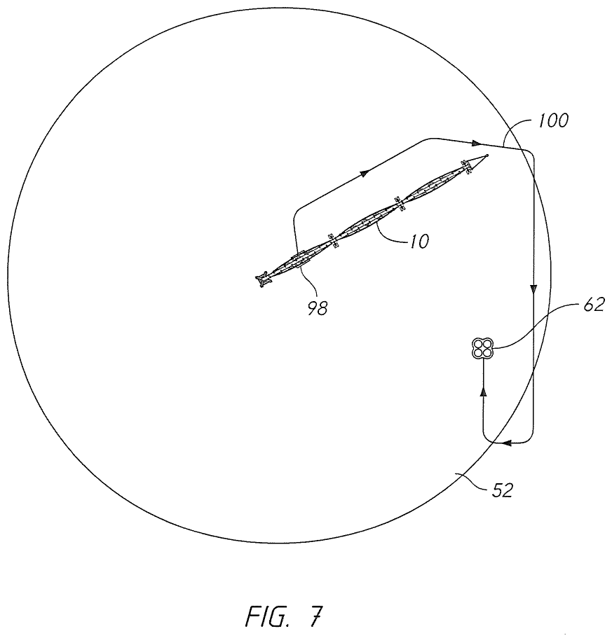

Shortly before an irrigation cycle is initiated, the UAV is dispatched to survey the irrigation circle. FIG. 7 shows this operation. UAV 62 flies away from UAV base station 98 and flies along flight path 100. Flight path 100 is typically a prescribed pattern that provides good coverage of irrigation circle 52 (The irrigation circle is the irrigation area in question for a center pivot system. In other system types the irrigation area will not be a circle). In the example shown, the pattern is a series of parallel paths.

Existing flight planning software may be used to create a desired flight pattern and the present invention is by no means limited to any one pattern. If, for example, GPS data is unavailable on a particular day, the UAV may be equipped with a computer vision system that allows it to fly a pattern based on the wheel tracks of the irrigation system itself. Switching to vision-based information may also suggest the desirability of a different flight pattern and such a flight pattern can be stored in memory for use when needed.

The UAV may use any desired sensor or sensors. As one example, the SWIR return serves as a good proxy for moisture content. The UAV may use a SWIR sensor to gather data. The UAV correlates this data with GPS-based positional data and preferably time data as well. In other words, each datum point would have a SWIR value, a GPS position value, and a time value.

The UAV then downloads the data acquired to CPU/memory 104. Software running on the CPU then analyzes the data. Positional accuracy is important for this analysis. It may be desirable to provide a “reference GPS receiver” that is located on a point fixed by an accurate survey. Such a point is preferably near the field. The signal from this reference GPS receiver may be used to determine the existence of any positional errors in the GPS system on board the UAV at any time. These positional errors may then be backed out of the GPS data.

A simple example will explain this process. The reference location for the reference GPS receiver is very accurately surveyed. The reference receiver is then fixedly attached to this point. If the reference receiver receives and decodes a GPS signal indicating that it is 2 meters west of its known position, then the software running on the CPU “knows” to move all GPS data taken at that time 2 meters to the east. This technique is well known in the field of surveying and may be used to greatly enhance the accuracy of mobile GPS systems.

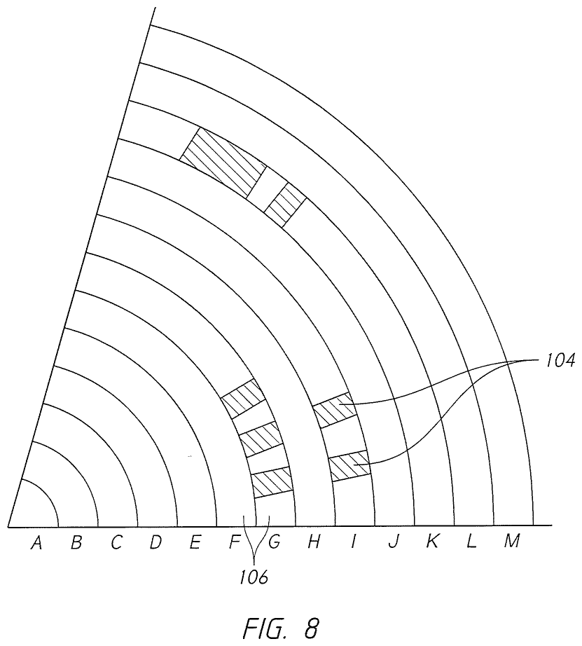

The software eliminates positional overlaps to create a unified and accurate “snapshot” of conditions within the irrigation circle. This data is then used to create an irrigation schedule or zone map. FIG. 8 shows an exemplary irrigation schedule. A portion of the motion of the boom assembly is shown as an arc in the view. Individual sprinklers are designated as A-M. Each sprinkler covers a sprinkler coverage arc 106. At certain portions during the travel of the booms individual sprinklers are turned off. These are designated as exclusion periods 104 in the view. In this example the valves 88 are simple on/off devices. A maximum saturation for all areas would be achieved by leaving all valves on all the time. A selected reduction in some areas is achieved by turning some valves off some of the time. In other embodiments a more complicated valve might be employed. This type of valve could have three positions or more (such an off, on-low, and on-high). This would give the system more variability in control.

It is preferable for the UAV to fly a pattern and build a data set immediately before an irrigation cycle begins. That way the very latest information is used. The term “immediately” in this context means within 8 hours and preferably within 1 hour. Even more preferably, the data set is completed within 10 minutes of the initiation of the irrigation cycle.

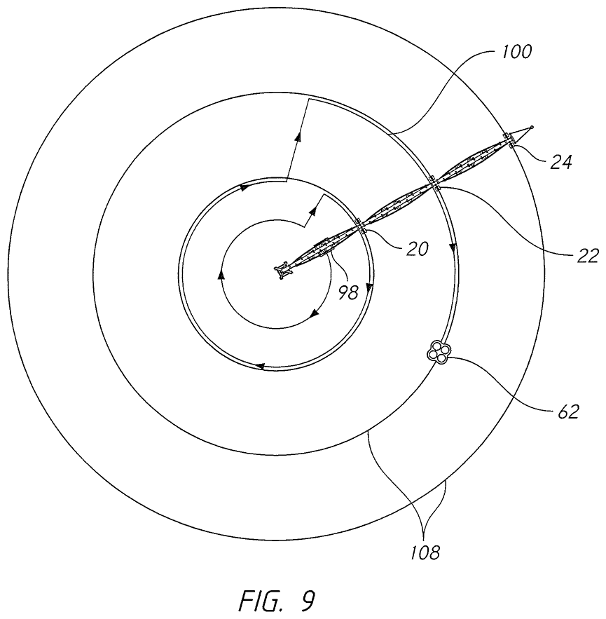

The flight path used for the survey may be driven in different ways. As described previously, GPS data may be used to define the flight path. However, GPS data may not always be available. FIG. 9 shows a plan view of a line of spans using three drive towers 20, 22, 24. As those skilled in the art will know, each drive tower tends to create its own circular wheel track 108. These wheel tracks may be detected by a computer vision system located on the UAV. The UAV may easily follow the wheel track. Flight path 100 in the example of FIG. 9 starts at UAV base station 98 and then follows a wheel track. While the UAV is flying this pattern, it will capture images from an altitude in regards to camera resolution for centering the image based on the wheel track. The image will typically be rectangular. Because the UAV is flying a circular pattern the images should be taken at intervals that will produce an overlap between the edge of one image and the edge of the adjacent image. Images can be stitched together (using software) by connecting and overlapping edges by calculating the angle direction in which the UAV is in regards to the wheel track and previous image captured. This will create multiple point overlap for images in a circular direction. The software can then be used to create a unified data set for the area if desired).

In this example, the UAV includes a digital flux compass that is able to measure the UAV's heading within +/−5 degrees. Once the UAV has followed a wheel track through 330 degrees Of heading change, the UAV is programmed to make a 90 degree left turn and proceed outbound until it intersects the next wheel track. The UAV then follows the next wheel track and continues the process. Obviously there are many different ways to use the wheel tracks to guide the survey pattern. Other existing features may be used—such as the boundary between irrigated and non-irrigated regions.

The central processing unit described may assume a wide variety of forms. In general, an irrigation schedule or plan is created by control software running on a processor-based control system. The processor-based system may include a remote server or servers that actually creates the irrigation schedule and then downloads it to a programmable logic controller (including another processor) located on or near the irrigation system itself. Thus, although the control software may be run on a single processor the inventive method described herein may also be carried out using multiple processors that are not in the same location.

Looking again at the irrigation plan of FIG. 8, those skilled in the art will realize that the angular position of the line of irrigation booms is important to the execution of the plan. Returning to FIG. 2, the reader should note that collector ring 28 typically includes an angular position sensor in addition to the other slip rings. This angular position sensor “tells” the control software where the booms are in their slow movement around the irrigation circle. Thus, the control software knows when a particular sprinkler head is passing over a particular arc segment that is scheduled to receive more or less liquid. The control software then modulates the valve feeding that sprinkler head accordingly (“modulation” meaning simply changing the state of flow through the valve).

Other embodiments of the invention will include other features, such as;

1. The valves may be controlled wirelessly, with only the power signal being hard-wired;

2. A UAV stored in a UAV base station on one center pivot boom may be used to acquire data for one or more other separate center pivot irrigation circles (with the data acquired being loaded into a CPU/memory associated with the other center pivot system; and

3. Digital video camera sensors may be used on the UAV to build an accurate visible-light map of the irrigation circle.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the claims ultimately drafted, rather than by the examples given.

Having described my invention, I claim:

1. An irrigation area optimization system, comprising:
(a) a center pivot irrigation system, including,
(i) a central pivot structure,
(ii) a plurality of boom assemblies pivotally connected to said central pivot structure,
(iii) a plurality of sprinkler heads mounted on said plurality of boom assemblies;
(b) an unmanned aerial vehicle base station attached to said center pivot irrigation system, including an unmanned aerial vehicle landing pad,
(c) an unmanned aerial vehicle, comprising,
(i) a control system configured to automatically operate said unmanned aerial vehicle so that said unmanned aerial vehicle lifts off said unmanned aerial vehicle landing pad, flies over said irrigation area, and lands back on said unmanned aerial vehicle landing pad,
(ii) a sensor array configured to collect data regarding said irrigation area as said unmanned aerial vehicle flies over said irrigation area,
(d) a processor and an associated memory, with said processor running software;
(e) a wireless communication link between said unmanned aerial vehicle and said processor, said wireless communication link configured to transmit data regarding said irrigation area gathered by said unmanned aerial vehicle to said processor;
(f) said software running on said processor being configured to create an irrigation schedule for said center pivot irrigation system based on said data from said unmanned aerial vehicle; and
(g) said center pivot irrigation system being configured to execute said irrigation schedule.

2. The irrigation area optimization system as recited in claim 1, comprising:
(a) a cover for said unmanned aerial vehicle base station;
(b) said cover being selectively movable from an open position allowing access to said unmanned aerial vehicle landing pad to a closed position covering said unmanned aerial vehicle landing pad; and
(c) an actuator configured to move said cover from said open position to said closed position.

3. The irrigation area optimization system as recited in claim 2, wherein said cover is configured to automatically move to said closed position after said unmanned aerial vehicle lands on said unmanned aerial vehicle landing pad.

4. The irrigation area optimization system as recited in claim 1, wherein said unmanned aerial vehicle base station includes an inductive charging system for charging said unmanned aerial vehicle.

5. The irrigation area optimization system as recited in claim 1, further comprising:
(a) a reference GPS receiver located on a surveyed point proximate said irrigation area; and
(b) wherein said processor uses data from said reference GPS receiver to remove positional errors.

6. The irrigation area optimization system as recited in claim 1, wherein:
(a) said unmanned aerial vehicle is configured to navigate to a position over said unmanned aerial vehicle landing pad using GPS data;
(b) said unmanned aerial vehicle includes a vision system;
(c) said unmanned aerial vehicle landing pad includes a plurality of targets; and
(d) once in position over said unmanned aerial vehicle landing pad, said unmanned aerial vehicle is configured to descend to said landing pad by using said vision system to locate said plurality of targets.

7. The irrigation area optimization system as recited in claim 1, wherein:
(a) one of said boom assemblies includes a pipe; and
(b) said unmanned aerial vehicle base station is attached to said pipe.

8. The irrigation area optimization system as recited in claim 1, wherein said irrigation schedule modulates an amount of water produced by said sprinkler heads as said plurality of boom assemblies pivot about said central pivot structure.

9. The irrigation area optimization system as recited in claim 1, wherein:
(a) said center pivot irrigation system includes a plurality of drive towers, with each drive tower producing a wheel track as said plurality of boom assemblies pivot about said central pivot structure; and
(b) wherein said flight of said unmanned aerial vehicle over said irrigation area follows a path based at least in part on said wheel tracks.

10. The irrigation area optimization system as recited in claim 2, wherein
(a) said center pivot irrigation system includes a plurality of drive towers, with each drive tower producing a wheel track as said plurality of boom assemblies pivot about said central pivot structure; and
(b) wherein said flight of said unmanned aerial vehicle over said irrigation area follows a path based at least in part on said wheel tracks.

11. An irrigation area optimization system, comprising:
(a) a center pivot irrigation system, including,
(i) a central pivot structure,
(ii) a boom assembly pivotally connected to said central pivot structure,
(iii) a plurality of sprinkler heads mounted on said boom assembly,
(iv) a drive tower connected to said boom assembly, said drive tower including a driving wheel;
(b) an unmanned aerial vehicle base station attached to said center pivot irrigation system, including an unmanned aerial vehicle landing pad,
(c) an unmanned aerial vehicle configured to automatically lift off said unmanned aerial vehicle landing pad, flyover said irrigation area, and land back on said unmanned aerial vehicle landing pad,
(d) wherein said unmanned aerial vehicle includes a sensor array configured to collect data regarding said irrigation area as said unmanned aerial vehicle flies over said irrigation area,
(e) a processor and an associated memory, with said processor running software;
(f) a wireless communication link between said unmanned aerial vehicle and said processor, said wireless communication link configured to transmit data regarding said irrigation area gathered by said unmanned aerial vehicle to said processor;
(g) said software running on said processor being configured to create an irrigation schedule for said center pivot irrigation system based on said data from said unmanned aerial vehicle; and
(g) said center pivot irrigation system being configured to execute said irrigation schedule.

12. The irrigation area optimization system as recited in claim 11, comprising:
(a) a cover for said unmanned aerial vehicle base station;
(b) said cover being selectively movable from an open position allowing access to said unmanned aerial vehicle landing pad to a closed position covering said unmanned aerial vehicle landing pad; and
(c) an actuator configured to move said cover from said open position to said closed position.

13. The irrigation area optimization system as recited in claim 12, wherein said cover is configured to automatically move to said closed position after said unmanned aerial vehicle lands on said unmanned aerial vehicle landing pad.

14. The irrigation area optimization system as recited in claim 11, wherein said unmanned aerial vehicle base station includes an inductive charging system for charging said unmanned aerial vehicle.

15. The irrigation area optimization system as recited in claim 11, further comprising:
(a) a reference GPS receiver located on a surveyed point proximate said irrigation area; and
(b) wherein said processor uses data from said reference GPS receiver to remove positional errors.

16. The irrigation area optimization system as recited in claim 11, wherein:
(a) said unmanned aerial vehicle is configured to navigate to a position over said unmanned aerial vehicle landing pad using GPS data;
(b) said unmanned aerial vehicle includes a vision system;
(c) said unmanned aerial vehicle landing pad includes a plurality of targets; and
(d) once in position over said unmanned aerial vehicle landing pad, said unmanned aerial vehicle is configured to descend to said landing pad by using said vision system to locate said plurality of targets.

17. The irrigation area optimization system as recited in claim 11, wherein:
(a) one of said boom assemblies includes a pipe; and
(b) said unmanned aerial vehicle base station is attached to said pipe.

18. The irrigation area optimization system as recited in claim 11, wherein said irrigation schedule modulates an amount of water produced by said sprinkler heads as said plurality of boom assemblies pivot about said central pivot structure.

19. The irrigation area optimization system as recited in claim 11, wherein:
(a) said center pivot irrigation system includes a plurality of drive towers, with each drive tower producing a wheel track as said plurality of boom assemblies pivot about said central pivot structure; and
(b) wherein said flight of said unmanned aerial vehicle over said irrigation area follows a path based at least in part on said wheel tracks.

20. The irrigation area optimization system as recited in claim 2, wherein
(a) said drive tower produces a wheel track as said boom assembly pivots about said central pivot structure; and
(b) wherein said flight of said unmanned aerial vehicle over said irrigation area follows a path based at least in part on said wheel track.
